(19) United States
(12) Patent Application Publication
(10) Pub. No.: US 2016/0379326 A1
(43) Pub. Date: Dec. 29, 2016

(54) RISK MODELING SYSTEM

(71) Applicants: Marie N. Chan-Gove, Simi Valley, CA (US); Chate Asvanonda, Newbury Park, CA (US)

(72) Inventors: Marie N. Chan-Gove, Simi Valley, CA (US); Chate Asvanonda, Newbury Park, CA (US)

(21) Appl. No.: 14/751,050

(22) Filed: Jun. 25, 2015

(51) Int. Cl. G06Q 50/26; G06F 17/30; H04L 29/06

(52) U.S. Cl. CPC G06Q 50/265; H04L 63/1433; G06F 17/30994; G06F 17/3053

(57) ABSTRACT

The system provides early warning intelligence feeds which analyze risks of potential human caused threats and naturally caused hazards. It includes data mining functions that autonomously search and categorize threats/hazards from worldwide open source data on a continuing basis. Data comes from many news feeds, social media feeds, government databases, etc. Key word analyses allow potential threats/hazards to be sorted into categories traditionally used by government agencies. Physical and cybersecurity vulnerabilities are analyzed and measured with threats to disclose potential impacts to people, properties, processes, special events, and related critical infrastructures and industries. Overall risk scores are instantly displayed as color coded icons on a worldwide electronic map/dashboard at any geolocation. Daily Intelligence reports and certain immediate alerts are also produced.

### BACKGROUND OF THE INVENTION

A. Field of the Invention

This invention relates, generally, to modeling potential security risks discovered from an ongoing search for potential threats and natural hazards. Physical security and cybersecurity risk scores are produced from proprietary analyses which are analyzed against the users' physical and Cybersecurity vulnerabilities. The results are easy to use risk analyses, which are based upon a comprehensive intelligence product designed to make forecasting of security risks more reliable.

B. Description of the Related Art

Threats (human-caused) and hazards (naturally occurring threats) are potential events which might be harmful to the safety and security of people, property, processes (e.g. processes of public entities, private industry, etc.) and special events. Such potential threats are usually easier to understand in the context of particular geographical areas and locations.

Risk based security assessments analyze potential threats/hazards and their consequences so that users can be better prepared when they turn into actual events. The invention helps to identify and predict associated threats, which often accompany certain threats/hazards and may have related impacts. Identifying these potential impacts allow users to better plan for appropriate countermeasures and mitigation options. Historically, this entire process can take days or even weeks to achieve. However, this invention differs from prior art in that, among other things, it both greatly speeds up the process to allow instant analyses upon request of multiple factors viewed in light of a dynamically changing sphere of real-time information gleaned from many sources. It may also offer a more comprehensive, novel and unique analyses on a regular basis.

Just one such example of how the present system improves materially on the prior art is its focus on “Convergence”. This refers to the security industry's goal of including both cybersecurity and physical security risk factors in the overall risk assessments.

Large server farms, some of which are today often referred to as “the cloud” are subject to increasing cyber risks. However, in fact they are all actually located in physical buildings or structures, with all of their attendant physical security issues. The invention “converges” both physical and cybersecurity risks in proprietary ways never done before.

The invention includes other proprietary and unique analyses which have never been used or automated before. These new levels of comprehensiveness produce more accurate forecasts of risks and therefore improve users' preparedness and response efforts.

The invention produces some analyses related to security needs of users, which may optionally be part of the risk scoring system, but which are very helpful.

Several of the components of the invention are novel and proprietary, including its unique matrices e.g. its dictionaries, and its unique analyses that produce its overall scoring system. Another such unique component is its DAVA assessment (Domain Awareness Vulnerability/Threat/Hazard Assessment) and how it utilizes, for example, the NGA's (National Geospatial Intelligence Agency) worldwide data base. Many of these components have been created and/or combined for the first time. This combination has resulted in a system which greatly improves the reliability of risk based forecasting of potential threats and hazards.

It is also noteworthy that comprehensive and current risk based security assessments have now become policy for the federal government. This policy has been adopted both for the protection of its own agencies and a condition of certain federal grants to state and local governments. The invention is the first product to: combine many of these new government policies with traditional security industry standards; add additional proprietary components based in part on real time and/or near real time streaming data and situation specific concerns to further make overall risk based forecasts more reliable; and provide unique automation of its components.

The present invention addresses one or more of the problems and deficiencies of the prior art discussed above. The invention may also prove useful in addressing other problems and deficiencies in a number of technical areas. Therefore, the disclosed invention should not necessarily be construed as limited to addressing any of the particular problems or deficiencies discussed herein. The examples are intended to be illustrative and not limiting.

Other patents describing the closest subject matter provide for a number of more or less complicated features. These fail to meet the need for current and comprehensive overall risk assessments and forecasts for the security industry in such an efficient, novel and economical way. None of these patents suggest either the novel features or the comprehensiveness of the present invention.

### SUMMARY OF THE INVENTION

In order to keep up with constantly changing risk factors, today's security industry needs access to more meaningful analyses on a real time and/or near real time basis. Another new challenge is today's overabundance of potentially relevant data from sources around the world. The present system in its various iterations addresses these situations as its proprietary components analyze data from a wide variety of sources. These include, merely by way of example and not to be interpreted as an exhaustive recitation, RSS feeds from aggregated news sources and social media such as Twitter. Other sources could potentially include: data bases from NASA (satellites); NOAA (live weather sensors); USGS (ground sensors); the National Geospatial Intelligence Agency (with its millions of data points from around the world regarding structures, terrain features, and buildings); and, the Global Terrorism Data Base (from the Study of Terrorism and Responses to Terrorism). Many more sources of external data that currently exist or will come in the future may play an integral role in supplying information relevant to a comprehensive risk analysis.

In a version of the system, a Data Discovery component identifies and selects which sources of data will be accessed, so that relevant data can be analyzed by the invention's Matrices and other components.

In a version of the system the Data Matrices have several components which perform various analyses. These include multiple powerful data mining dictionaries (ontologies). These dictionaries continuously search and sort through the overabundance of open source (non-classified/non restricted) data. With appropriate permissions, the dictionaries can also be used with restricted data. Of course there could be more or fewer data mining dictionaries depending on the particular application of the system.

A computer uses dictionaries to search selected data sources on a 24/7 basis. In this example, the first of these dictionaries is called the threat dictionary. It sorts and categorizes data into one of a group of preselected potential threat/hazard categories e.g., demonstrations, robberies, bombings, earthquakes, etc. To do this a proprietary ontology of many key words were researched and assembled for their relevance to each of the categorized threats.

Another valuable Data Matrix's dictionary is its Critical Infrastructure/Key Resource (CI/KR) dictionary. This dictionary searches and categorizes data to identify potentially impacted CI/KR's in accordance with a predetermined set of potentially impactful parts of infrastructure and resourced. One optional source of this information is derived from the Department of Homeland Security's Critical Infrastructures/Key Resource system e.g. Dams, Financial Sector, Emergency Services, etc.

Optionally another Data Matrix dictionary searches data for geographical locations of potential threats/hazards. This component searches through the textual data from online sources such as by way of example: articles, twitter feeds, data bases, etc. and looks for things like the mention of a city or landmark, and/or performs other proprietary processes, so that it can determine the geographical location i.e. Latitude/Longitude.

Next, the Data Matrix uses predefined sub-matrices to analyze the categorized information against predefined industry standards, to improve its accuracy in the forecasting of potential impacts/consequences and related threats. Potential levels of impact and potential associated threats are forecasted from predefined matrices which provide additional input for overall risk scores.

In one version of the system, once the identity and location for a user is known, the location(s) is geo-located on an electronic map and represented by a color coded icon, called an AOI or Area(s) of Interest. Since the system will also know the Lat./Long of each potential threat, it will perform a more detailed analysis of only those threats and hazards that are within the predefined distances from the user's specific locations or within a set perimeter.

Another optional but preferably present aspect of the invention is its Threat Atmospherics component. One subcomponent of Threat Atmospherics is its capability to take selected threats/hazards and analyze their capability for harm to the user's AOI.

Another available subcomponent of Threat Atmospherics is called DAVA (Domain Awareness Vulnerability/Threat/Hazard Assessment). DAVA measures additional potential situational security threats which may be posed by nearby buildings, structures and terrain features.

The overall Threat Atmospheric score becomes part of the calculation of the overall risk score for each Area of Interest (AOI).

In at least one embodiment the invention offers users the option of matching calculated threats and impact scores with specific vulnerability scores for each of the users' AOI's. These vulnerability scores come from both physical security and cybersecurity assessments of users. These vulnerability scores are typically at least in part obtained from answers to questions which can be answered by the user as a self-assessment or by an agent. A separate embodiment of the invention allows for users to add their own user specific vulnerability questions. The questions can be mapped into the invention's proprietary linkage system that will measure the threat score to the questions' answers, and calculate the potential impacts of the threats to the vulnerabilities.

Further detail of the invention will be brought out in the following part of the specification, wherein more detailed descriptions are given for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a flow chart the Data Discovery Function.

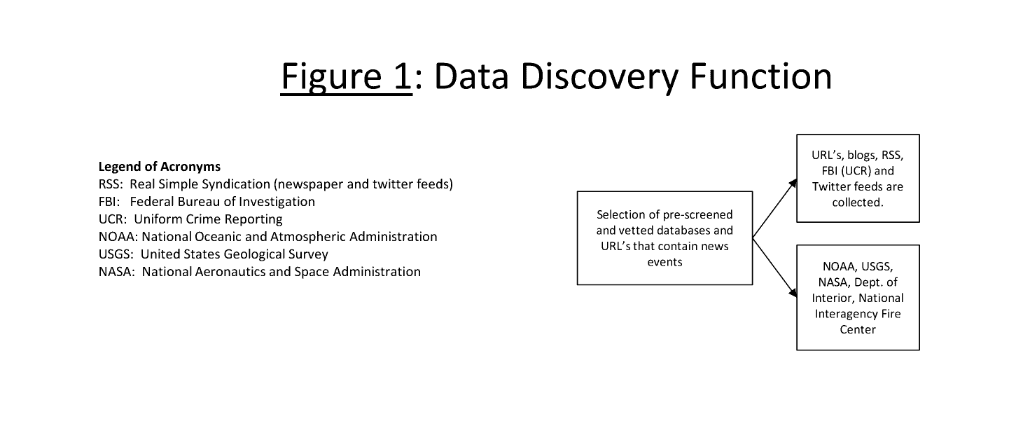

FIG. 2 shows the Data Matrix Function.

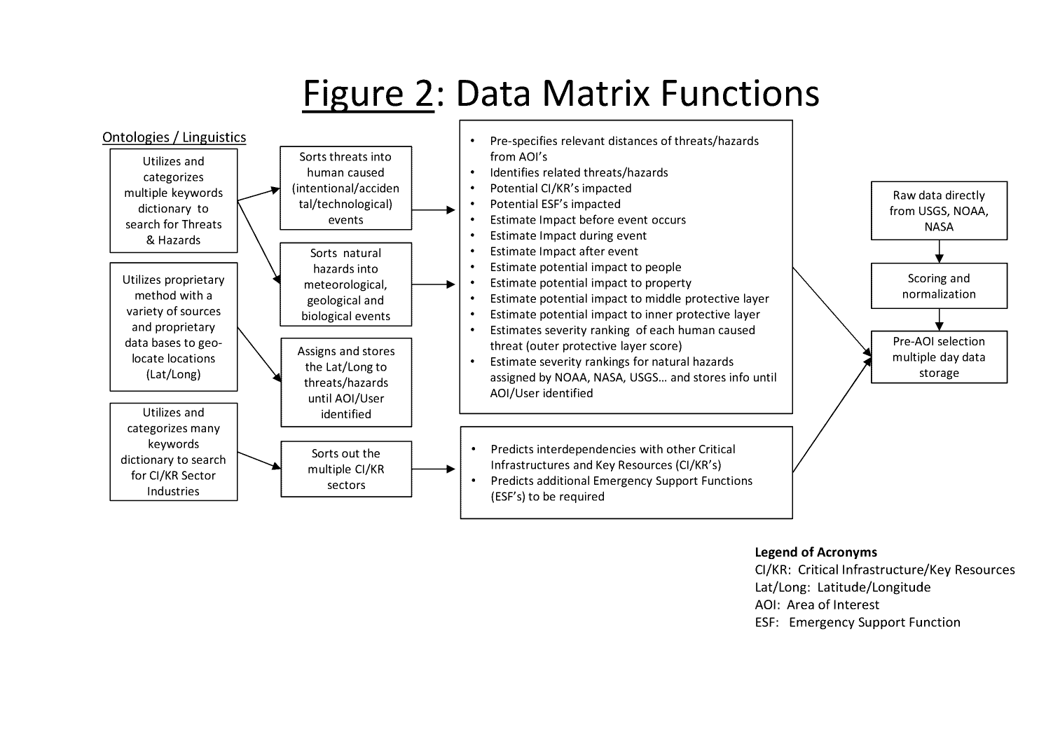

FIG. 3 and FIG. 4 combined shows the Electronic Map Dashboard and Areas of Interest (AOI's).

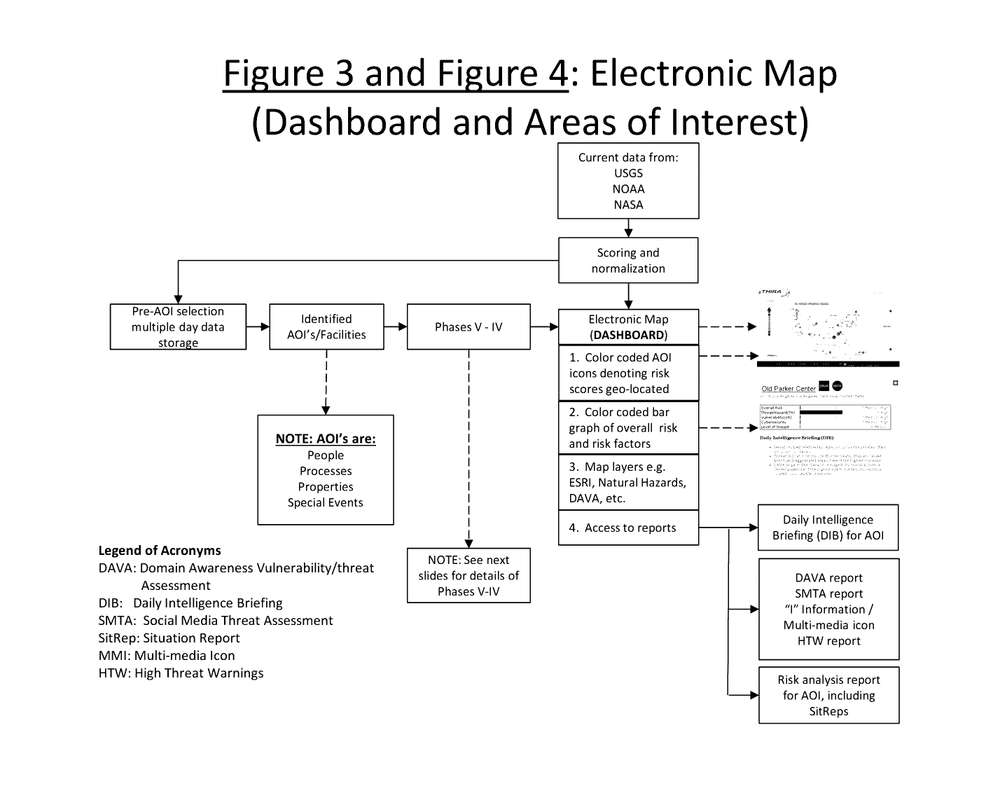

FIG. 5(a) shows Threat Atmospherics (Threat/Hazard Analysis)

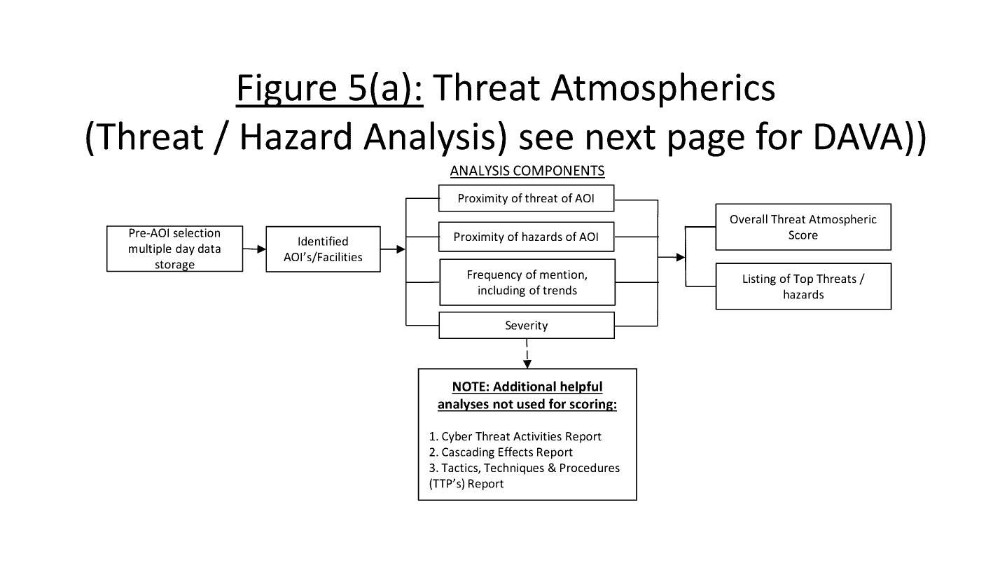

FIG. 5(b) shows Threat Atmospherics (DAVA Domain Awareness Vulnerability/Threat/Hazard Analysis))

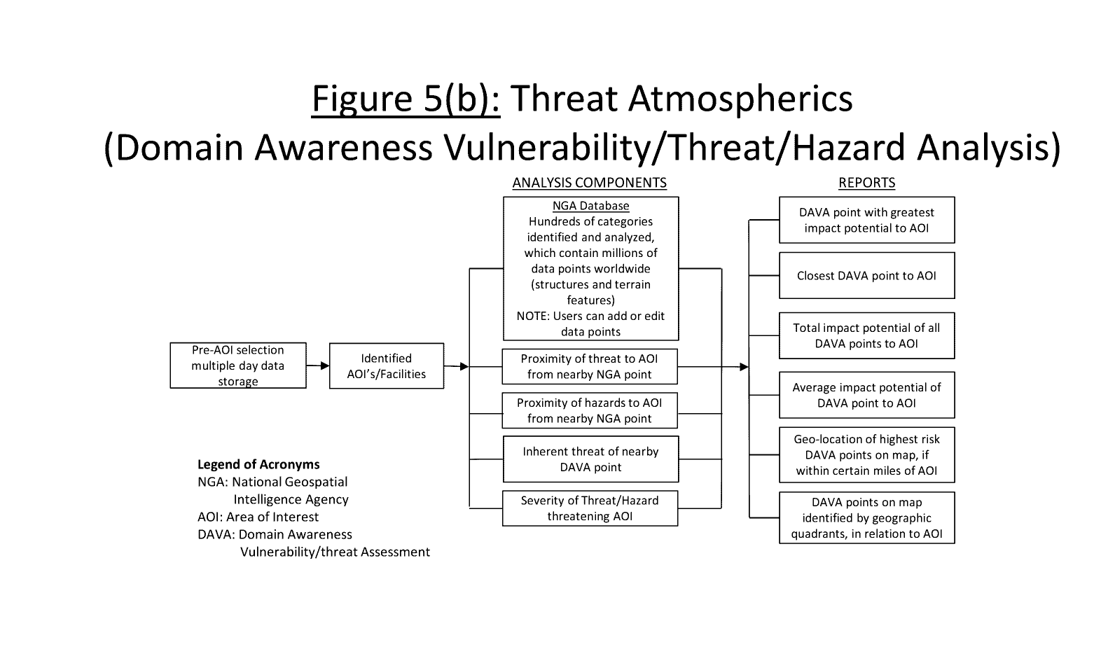

FIG. 6 shows Physical SVA (Site Vulnerability Assessment).

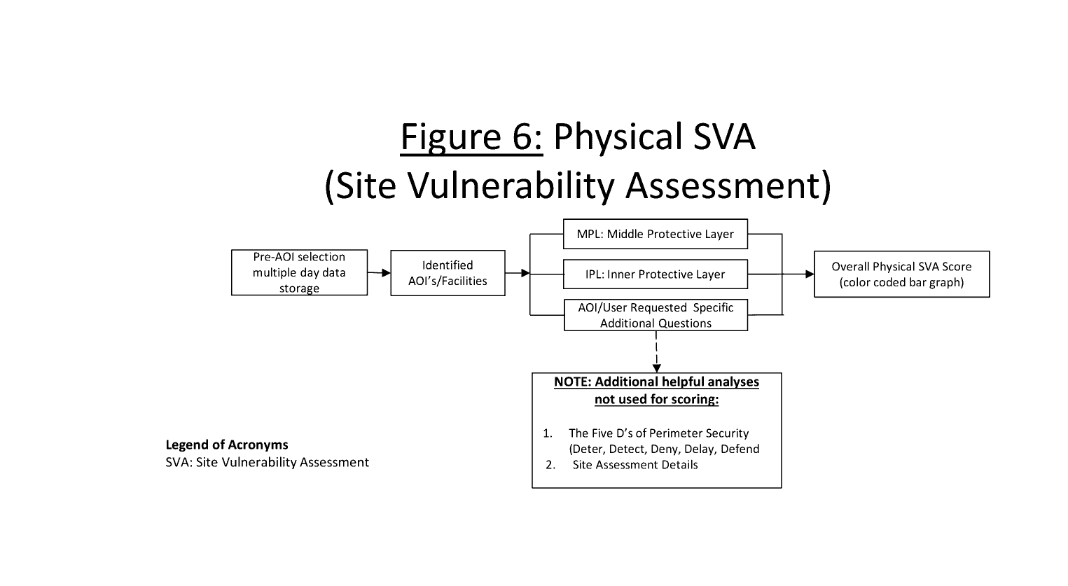

FIG. 7 shows Cybersecurity Vulnerability Assessment

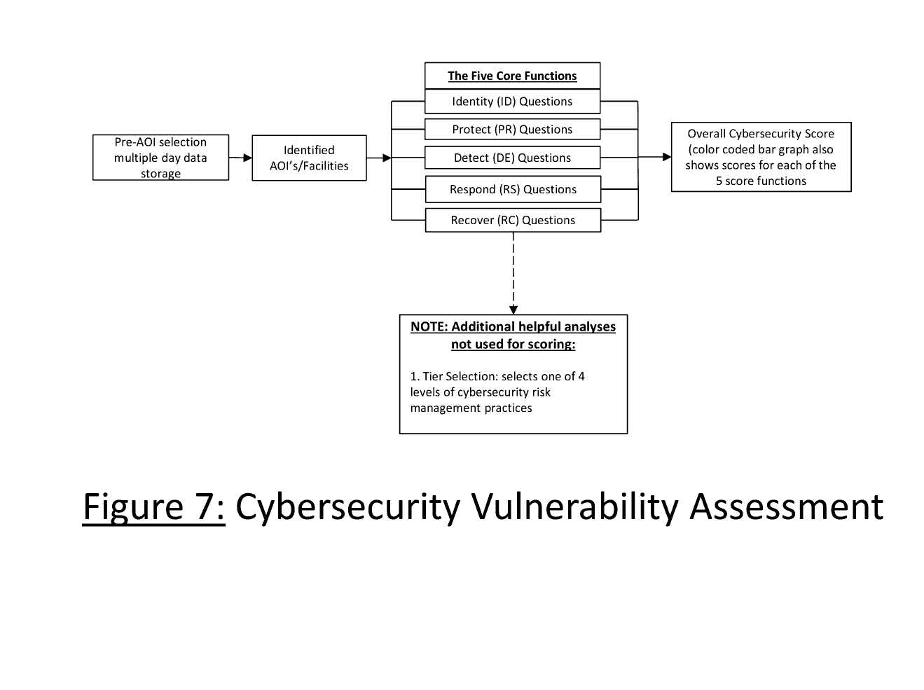

FIG. 8 shows Impact/Consequences.

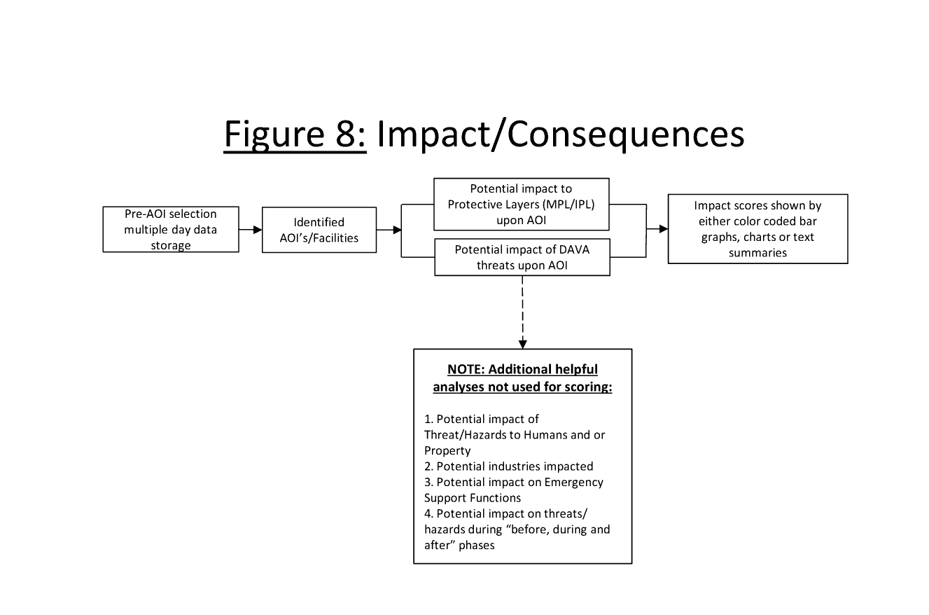

FIG. 9 shows a chart of the AOI Risk Analysis Report.

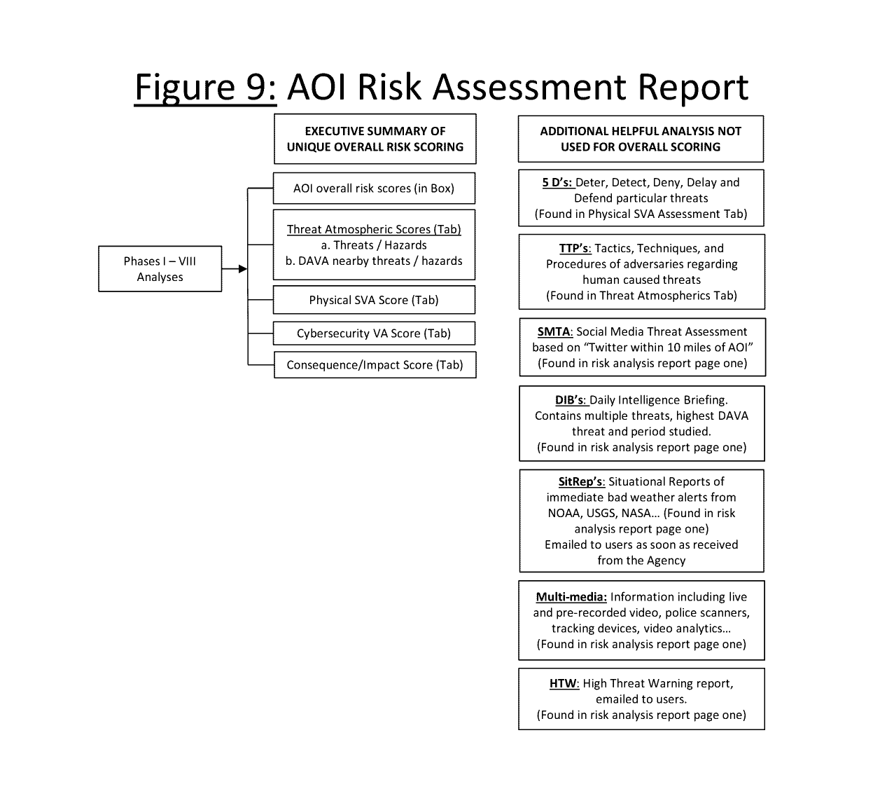

### DETAILED DESCRIPTION OF THE INVENTION

The following detailed description of the invention incorporates the above drawings in Section D. The Summary of Invention in Section C illustrates the specific embodiments of the invention. Other embodiments may be utilized and structural changes may be made without departing from the scope of the invention.

Phase one of the invention's process/methodology is called its Data Discovery function.

The system monitors and analyzes data from pre-selected aggregated sources of data on a continual and widespread basis. Data sources might include any individual or combination of the following examples:

Thousands of RSS (Really simple syndication) news feeds, twitter news feeds, and blogs, e.g. from CNN, ABC, NY Times, FBI, CIA, FDA, WHO, U.N., Google News (state, local and other newspapers), other countries e.g. UK, Mexico, etc. Any other available online news or information source could also be effectively used alone or in conjunction with the above examples as may be appropriate for a particular application of the system.

Data bases from government and private agencies may also optionally be used including:

National Geospatial Intelligence Agency (NGA)—contains geospatial intelligence (“GEOINT”) i.e. locations and identifications of millions of structures, buildings and terrain features around the world.

US Geographic Survey (USGS)—natural hazard data from around the world e.g. earthquake, floods, volcanoes, drought, etc.

National Aeronautics and Space Administration (NASA)—Satellite feeds containing hotspots for wildfires, air quality info, etc.

National Oceanic and Atmospheric Administration (NOAA)—storm and weather data from live sensors.

Global Terrorism Data Base (GTD)—from the Study of Terrorism and Responses to Terrorism (START).

Social media such as Twitter, and many other sources e.g. blogs, etc.

The above are merely illustrative and many other presently existing or future digital information sources may also be employed with varying effectiveness depending on the specific application of the system.

One of the major benefits of the invention is to help users have an automated sorting and analyzing of the overabundance of open source data available today where permissions are not necessary. With appropriate permissions, the invention can also be used with restricted/classified data.

Phase two is the Data Matrix function. This function uses several sub-processes to search, sort and categorize data for a preselected location and on a continual basis. An initial sub-process is its use of data mining capabilities. Dictionaries have been created which search a wide variety of sources of data, and which can be modified to search data in any language. These dictionaries consist of thousands of pre-identified words and phrases which enables a proprietary sorting of raw data. These pre-identified words were chosen for the invention as a result of extensive research. The result is an automated sorting and categorization into, for example: (a) predesignated threat/hazard categories, (b) specific latitude/longitude locations, and (c) appropriate categories of CI/KR (Critical Infrastructure/Key Resources).

A primary dictionary searches and sorts raw data into one of a variety of preselected categories of threats/hazards. These categories are comprised of three broad threat categories namely human caused threats, naturally occurring threats (hazards) and technologically caused adverse events. The system defines each threat, hazard or technological event utilizing a set of appropriate for the application standards. As a result of extensive research, over 10,000 words and phrases have been selected for their relevance to the multiple categories. Upon discovery in the raw data source, each of these words could potentially indicate one or more threats and/or hazards. This dictionary is also used to support an additional component of the invention called Social Media Threat Assessment (SMTA) which searches large amounts of twitter or other available digital sources of information within a set distance from a designated location or within a predefined perimeter around the subject location. This dictionary allows the SMTA to sort raw twitter feeds into appropriate threat categories.

This component then ranks the categorized threats for their potential danger to entities such as persons, properties and/or processes. (E.g. a detected murder ranks higher than detected vandalism).

Another dictionary then searches and sorts raw data for categorization into one of several CI/KR sectors (Critical Infrastructure/Key Resource sectors). Examples include the nation's health system, the education, transportation, power, financial and emergency services sectors. Each sector has its own critical resources including important assets, systems, buildings and networks deemed to be vital.

An example of how the CI/KR dictionary would work is if it discovers the word ‘tornado’ the invention will automatically associate that with the emergency services sector, which includes police and fire departments. If the word ‘commuter train’ is discovered, the invention would associate it with the transportation sector. The dictionary that has been shown to be effective has over 6000 words and phrases which have been selected for their relevance to CI/KR's. Upon discovery in the raw data sources, each of these words will indicate one or more CI/KR's.

In an important embodiment another dictionary assigns a specific geographical location (latitude/longitude) to the categorized threats. In addition to its own ontology of words and phrases, this dictionary has access to a variety of sources and other information so that if it spots the name of a city or a well-known landmark it will identify the corresponding latitude and longitude. It will also do this if a specific address of a threat/hazard is discovered. Another feature of the Data Discovery function is that all information received is time and date stamped and archived. This is important because of users' needs to know anniversary dates of terrorist events and other facts like seasonal weather patterns.

Another subcomponent of this phase is called “Events”, which is found on a Tab marked “Events”. This Tab displays a table which visualizes the results of analyses done by the dictionaries into multiple columns e.g. “Threat Number”, “Source”, “Headlines/Summary”, “Location”, “Event Date” etc. This is the information which is the result of tens of thousands of open source feeds which are collected every day. The “Events” Tab allows users to edit collected information and to enter new events. This is very important because sometimes users will learn of events before newspapers or twitter. Therefore these new entries can be fully integrated into the invention's powers of analysis.

The final subcomponent of this phase of the invention utilizes numerous predefined matrices to analyze various types of impacts/consequences, and to predict potential linkages. The system automatically triggers a cascading effect of related threat events if certain interdependencies occur.

These matrices assign predefined ratings based upon potential harm to people, property, processes and special events. Currently there are 11 such matrices making predictions, but that number can vary from a couple to several dozen depending on the application of the system. These predefined predictions are based upon the threats/hazards discovered by the dictionaries conducting their continual broad-range searches. Predictions of various types of impacts are stored for a period of time as needed. Therefore, once a user determines a specific location of concern, the stored information is instantly available to determine trends and patterns.

The first three of these submatrices contain important concepts from government publications such as “FEMA 426/BIPS 06—Reference Manual to Mitigate Potential Terrorist Attacks against Buildings”.

Physical security aspects of facilities are analyzed in three categories: One submatrix is Outer Protective Layer (OPL), another submatrix is Middle Protective Layer (MPL), and another submatrix is Inner Protective Layer (IPL). Based upon the nature of the discovered threat, an estimated impact score is assigned to two of three submatrices. Specifically, the MPL and the IPL receive these estimates. However, in the case of natural hazards, the score given to the OPL also reflects the actual rankings received from USGS, NOAA, NASA, etc. For example, if USGS says the Richter scale ranking is an 8.0, the OPL score might be 10.

Another submatrix predicts and defines associated threats i.e. secondary threats which are probable because of the nature of the primary threat. For example a demonstration might easily be followed by intentional threats and arson.

Another submatrix predicts which ESF's (Emergency Support Functions) will be required based upon particular discovered threats/hazards. ESF functions help support the nation's incident command system. It is their mission to assist incident response by providing certain resources according to their capabilities, tasking and requirements.

Another submatrix predicts which of the CI/KR (Critical Infrastructure/Key Resource) sectors will be impacted based upon the particular threat/hazard discovered. An example of how this predefining works is if it discovers the word ‘tornado’ the system will link this to the emergency services sector, which includes police and fire departments.

Other multiple submatrices are categorizations of potential threat/hazards by what stage they are in i.e. before, during or after its occurrence.

Another submatrix is an analysis of potential impact upon human beings. For example robbery would have a higher such impact score since it always involves a human being.

Another submatrix is an analysis of potential impact to property. For example burglary would always have a higher impact on property.

In another phase, a summary provides a continual broad-reaching monitoring of important threats and hazards. It also provides a sorting of raw data into appropriate threat and hazard categories. It then performs certain analyses of the potential impacts and consequences of these threats and hazards regardless of where they occur. It is not until AOI's are identified in the following phase below that the system analyzes how threats and hazards impact specific AOI's.

The next phase of the process develops a color coded electronic map which functions as a dashboard/viewer to make it easier for users to visualize and understand. Map layers are available as an overlay for topics such as worldwide natural hazards e.g. floods, wildfires, earthquakes, etc. Each natural hazard has a meaningful icon e.g. a flame icon represents a wildfire and is color coded based on reported heat levels. By selecting such an icon, current analyses made publicly available such as those prepared by NOAA, NASA or USGS can be displayed along with detailed information from their database. Updates occur periodically to refresh the data available to the system and the user.

Another layer is the geolocations of AOI's which are discussed in next phase below.

Another layer is DAVA geolocations. DAVA measures threats from structures and terrain features near the AOI. It is discussed in detail in the subsequent phase.

Other map layers can be added for specific users, such as Google Earth, Bing, etc. or for those with other specialized needs or uses.

In summary, the map not only visualizes important geolocations, it also maximizes information sharing. This sharing involves some of the most current government information about important topics such as natural hazards, and does so in a location specific manner.

In this phase of the process is a component called the Area of Interest (AOI). The Area of Interest (AOI) is a specific geographical location(s) which is selected by the end user because his people, property, processes, or special event is located there.

AOI's are color coded appropriate to their overall risk based assessment score. The colors are based upon The Department of Homeland Security guidelines or other basis for coloration. A score of 1-10 is the AOI's overall risk assessment score with 1 being the best and 10 the worst (with green indicating the best score and red the worst).

Once an AOI is geo-located and displayed as an icon, clicking on it also reveals a color coded bar graph. The graph has separate scores for the levels of overall risk, threats, hazards and impacts. These scores come from analyses in the phases described infra and supra. Clicking on an AOI icon also creates an option to display the full Risk Assessment Report for that AOI. These Reports are described in detail in a following phase below. Finally, clicking on an AOI displays the Daily Intelligence Briefing (DIB). This contains “period studied”, most severe threats discovered, and the nearby structure or terrain feature posing the most serious potential impact.

Another phase of the invention is a component called “Threat Atmospherics”, which has five subcomponents. It is found in the Risk Assessment Report for each AOI where it has its own tab. The first subcomponent is called “Threat/Hazard Analysis”, which is compiled from the Data Matrix dictionaries discussed in Phase II and other sources. The result is a determination of several important analyses of key criteria. These are (a) proximity of threat/hazards to AOI's; (b) frequency of mention; and (c) is severity. Regarding proximity, only those threats/hazards within pre-specified distances, zones or areas are analyzed for their potential for harm.

For example, an earthquake with a seismic reading above a 3.5 Richter will be analyzed even if it were 100 miles from an AOI. Analyses will be performed for burglary threats only if they are within 25 miles from an AOI, since they do not threaten as much harm as an earthquake. Regarding natural hazards, the system will give a higher or lower risk score based up the actual distance from an AOI. For a threat, the scoring is the same regardless of distance, provided the distance is close enough to be picked up at all.

Another criterion analyzed is the frequency of mention of threats/hazards within a set span of time. This is a number count in news articles, data bases, etc., for each threat/hazard contained within pre-specified distances. The data is stored for a period of time, so that it can better spot trends and patterns. For example the invention compares the number count for the last seven days with the mentions count for the previous 30 days. Sudden increases in frequency of mention (chatter) are often particularly reliable indicators of potential threats actually occurring. Accordingly, a special report called “High Threat Warning” (HTW's) is sent to users whenever such conditions occur.

The third criterion analyzed is the severity of threat. This identifies the potential level of harm inherent with particular threats/hazards. For example, murder would get a higher severity rating than would vandalism. Also included in the severity ratings is information from the data source e.g. NOAA which might include the category of a potential hurricane, category of tornado, etc.

Another aspect of the Threat Hazard Analysis component is that it also combines the above three factors (proximity, frequency and severity) into a listing which ranks the “Top Threats and Hazards”.

Another proprietary component of Threat Atmospherics is called DAVA (Domain Awareness Vulnerability/Threat/Hazard Analysis. DAVA examines “what if” the “Top Threats and Hazards” trigger additional situational security threats to an AOI due to its being near to certain buildings, structures and terrain features. The inherent threats of each of these nearby DAVA points are combined with their proximity to yield a risk score.

For example, DAVA discovers these potential nearby threats by searching the massive NGA (National Geospatial Intelligence Agency) data base. This gives exact geographic locations (Lat./Longs) and identifies some 8 million DAVA points (structures, buildings, terrain features, etc.) throughout the world. NGA sorts all this data into 700 categories. For each of these categories, DAVA has predetermined what the inherent threats are posed by the DAVA points in that category. To further illustrate this example, a nearby chemical factory might pose an inherent threat of a hazardous material disaster to an AOI which is an office building. DAVA has also predetermined which threats facing an AOI might more easily trigger these inherent threats. For example, a terrorist wanting to put a bomb in the chemical factory.

Users can also: (1) have new DAVA Points added to supplement the NGA database; and, they can edit existing DAVA points with updated information.

DAVA computes several other key factors. One is the total number of nearby facilities, buildings and terrain features which may pose inherent threats to the AOI. Another is an overall average potential impact score, which the DAVA points threaten as a whole. For another, it specifies which of these DAVA points would have the greatest impact upon the AOI if certain threats happened to the AOI. For another, it specifies which of the DAVA points is the closest one to the AOI. For another, it determines which DAVA points will appear on the electronic map. To do this it looks at distance from the AOI, severity of threat and type of building/facility. For yet another, it further selects which DAVA points will be on the electronic map by limiting those to a certain radius from the AOI. Seventh, the DAVA points which are selected for the map are identified by which map direction (quadrant) they are in based upon the AOI being in the center. By identifying and displaying DAVA Points this way, e.g. Northeast, Southwest, etc., users can better decide which direction is safest to use e.g. for evacuations, etc.

Another component of Threat Atmospherics is called “Cyber Activities”. These are cyber related activities which are discovered by the system for the last series of days (7 has been effective) as a result of its continuous broad-based searching. These are not included in overall risk scoring but are important for users to be aware of.

Another component of Threat Atmospherics is called “Cascading Effects”. These are the secondary impacts which might follow certain events should they actually occur.

Another component of Threat Atmospherics is called “Tactics, Techniques and Procedures”. TTP's are specific ways in which threats can be implemented by human adversaries. An example of a “technique” would be use of a pry bar during a threat categorized as a burglary. These are not always but may be included in the overall risk scoring and are important for users to be aware of.

Threat Atmospherics are sometimes referred to as the User's subjective estimate of all the threat information and analyses available to a user.

The next phase of the process is a proprietary component called “Physical SVA”, which assesses physical security vulnerabilities of specific AOI's. It is found in the Risk Assessment Report for each AOI where it has its own tab. This component has plural subcomponents.

One subcomponent is an actual physical site vulnerability assessment. Users have the option of doing self-assessments with these questions. These proprietary question and answer formats along with their accompanying rating scales are based upon the American National Standards Institute (ANSI) and industry experts. Examples of physical security issues include numbers of security guards, locks on doors, cameras, entry access cards and other similar factors.

This subcomponent is further broken down into 4 areas. They are Middle Protective Layer (MPL), Inner Protective Layer (IPL), the 5D's of Security and the Site Assessment Details.

The MPL refers to access roads, parking lots and other features located in between the site's property line and the building. Risks for each such item are analyzed and scored based upon answers received from the assessment.

The IPL refers to doors, walls, roofs, and other features of the actual buildings that are associated with the AOI. Risks for each such item are analyzed and scored based upon answers received from the assessment.

Another area is an analysis which groups certain AOI physical security vulnerabilities into 5 subcategories: Deny, Deter, Delay, Defend and Detect. This is called “The 5D's” analysis and it provides scores for all the risks in each of these categories. These results allow users to improve mitigation efforts and justifications.

These are not included in overall risk scoring and are important for users to be aware of.

Another area is called “Site Assessment Details”. This is a table which provides a detailed look at the topics, questions and specific answers of the AOI's physical security vulnerability assessment. Reports can be generated in various formats e.g. Excel, PDF and Word. This provides an in depth analysis of these topics.

Another subcomponent of the “Physical SVA” tab is a color coded bar chart which shows the Overall Physical Security score which is based upon the IPL and MPL scores.

Another phase of the process is a component called “Cybersecurity”, which assesses Cybersecurity vulnerabilities of specific AOI's. It is found in the Risk Assessment Report produced for each AOI in which it has its own tab. This component has several subcomponents.

A primary subcomponent is an actual Cybersecurity vulnerability assessment. Users again have the option of doing self-assessments with these questions. These proprietary question and answer formats along with their accompanying rating scales are based upon, for example, the government's National Institute of Standards and Technology (NIST).

Examples of cyber security issues include presence of firewalls, levels of encryption, network administration practices and other factors affecting electronic security, ability to recover from a cyber-attack, ability to respond to a cyber-attack and other issues as well.

Another subcomponent is called “Core Functions”. Five additional topics important to Cybersecurity of AOI's are prescribed by NIST with each topic having specific questions and scoring features. The core functions are: Identify, Protect, Detect, Respond, and Recover. “Identify” refers to identification of key people, devices and systems which might be impacted by a Cybersecurity event. “Protect” refers to the user's ability to protect itself from a Cybersecurity event. “Detect” refers to the user's ability to detect Cybersecurity events. “Respond” refers to the user's ability to respond to detected Cybersecurity events. “Recover” refers to the user's ability to recover from a Cybersecurity event.

Results of these five analyses allow users to obtain a more accurate level, strategic view of their organization's ongoing management of cybersecurity risks. Results also allow users to better estimate how quickly they can react to the actual occurrence of threats and hazards. These results are shown on color coded bar graphs which include actual scores for each function. These scores are also shown on the “Cybersecurity” tab in a color coded bar chart which includes an overall “Cybersecurity” score.

Another subcomponent is referred to as “Tiers”. Tiers is a NIST term which provides context on how an organization views Cybersecurity risk and the processes in place to manage that risk. Tiers range from Partial (Tier 1) to Adaptive (Tier 4) and describe an increasing degree of sophistication in Cybersecurity risk management practices and the extent to which Cybersecurity risk management is informed by business needs and is integrated into an organization's overall risk management practices.

Very importantly, both the physical and Cybersecurity vulnerability assessments can be modified by adding additional questions required by unique AOI situations. Virtually any type of assessment question can be added and the answers will have appropriate effects the AOI's overall risk scores.

In summary, the physical and cyber subcomponents of these phases allow the specific vulnerabilities of AOI's to become integrated with the relevant threat/hazard analyses already completed in earlier phases.

This combination of threat and vulnerability information achieves the relatively new high priority of the security industry called “convergence”. Convergence refers to the convergence of two historically distinct security functions—physical security and information security. Security convergence is motivated by the recognition that valuable corporate assets are increasingly information based. Whereas in the past physical assets demanded the bulk of protection efforts, today information assets demand equal (if not far more) attention.

Another phase of the invention is a proprietary component called “Impact”, which has several subcomponents. It is found in the Risk Assessment Report for each AOI where it has its own tab by that name. This phase determines overall impact and consequences to an AOI by analyzing the results of earlier phases.

One subcomponent is the “Level of Impact to the Protective Layers.” This component gives an “Overall Protective Layers Score” which is shown on a color coded bar graph. This score is the potential impact that the identified threats and hazards will have on the overall site. This “Overall” score results from two factors. The first factor is comprised of the types of threats/hazards, their frequency, their severity and their proximity to the AOI. The second factor measures the threats/hazards against the site's Middle Protective Layer and its Inner Protective Layer. The Middle Protective Layer includes property barrier systems, physical entry, access controls, etc.; and, the Inner Protective Layer includes doors, windows, walls, etc.

Another subcomponent is an analysis of the potential impact of identified threats to humans and/or property. For example, the potential impact upon human beings of a robbery would be higher than a burglary since robbery always involves a human being. Likewise, a burglary would always have a higher impact on property, since it always involves property.

Another subcomponent is an analysis of the “Potential Impact of DAVA”. This subcomponent details the number of nearby facilities, buildings and terrain features posing inherent threats to the AOI.

It also gives an average potential impact score to the AOI for all these DAVA points collectively. This subcomponent also specifies which of these DAVA points pose the greatest threat and which is the closest to the AOI.

Another subcomponent is an analysis of “Potential Industries Impacted”. This analysis determines which of the many industries may be affected by the threats and hazards facing AOI's. The system tallies the information and displays it within a bar graph which specifies the potential impact level to the affected industries.

Another subcomponent is an analysis of “Emergency Support Functions (ESF's). Which of the plural ESF's might be affected is displayed on a bar graph which specifies the potential impact level to the affected ESF.

Another subcomponent is an analysis which categorizes identified threats and hazards into three phases of the event cycle: before, during and after the event occurs. Each phase is shown on a chart which helps users better prepare the AOI with mitigation options and countermeasures.

The next phase of the invention is a proprietary component known as the ““Risk Analysis”. This component has multiple subcomponents and can be instantly produced for each AOI and downloaded to users.

One subcomponent is the “Executive Summary”. This contains a unique overall risk score which is color coded and based upon the results of analyses performed by the invention. The Executive Summary also contains the bar graphs which have already been described in their respective tabs. These show overall scores for Threat Atmospherics, Physical SVA, Cybersecurity and Impact.

The unique overall risk score is achieved by combining the risk factors facing an AOI. For example, assuming an AOI/facility has a high vulnerability assessment score e.g. inadequate exterior doors and intrusion devices; and, assuming the overall threat score is high because of a rash of burglaries near the AOI; and, assuming there was also a nearby DAVA Point which posed a threat to the AOI e.g. a nearby earthquake fault line dam with a high DAVA score; and, assuming an elevated cyber vulnerability score e.g. unprepared to recover cyber capability after disasters; then each of these proprietary risk factors would cause the risk score to go higher.

Another component of the “Risk Analysis” is comprised of several valuable outputs/analyses which are not included in the overall risk score. Some of these are displayed in the “Risk Analysis”, and others are located in other parts of the invention. Some of these utilize analyses of the invention and some do not. These additional outputs offer valuable intelligence products to users interested in their overall security risk situation. Many of these have been described in earlier Phases, including 5D's, TTP's, SMTA, DIB's, HTW's, SitReps, Multi-media Information.

For example, the 5D's are Deny, Deter, Delay, Defend and Detect. These describe an AOI's overall ability to withstand a particular physical security threat.

Another example are TTP's (Tactics, Techniques and Procedures) for use in better understanding what actions adversaries might be considering doing in connection with a particular threat.

Another example is the system's SMTA (Social Media Threat Assessment) capability. This function can provide the user with information coming from as source such as Twitter within a 10 mile radius of an AOI. This component utilizes the invention's threat dictionary to sort through the thousands of non-relevant “personal” type twitter messages and identify those in which potential threats are being discussed.

Another example is the system's ability to display a wide variety of multi-media. This includes live video feeds and video analytics, live police scanners, video and audio recordings, tracking devices with GPS for cellphones, vehicles, airplanes etc.

Another example is the ability to take bad weather alerts and warnings directly from NOAA and immediately pass them on to users. This is done with “Situational Reports” (SitReps), which utilize certain analyses of the invention.

Another example which utilizes certain of the invention's analyses is the DIB i.e. the Daily Intelligence Briefing. This is sent to users and is AOI specific regarding the top 3 threats, the top DAVA threat, and the period of time studied.

Another example which utilizes certain of the invention's components is the HTW (High Threat Warning) which is automatically sent to users when frequency of mention of certain threats (chatter) exceeds certain levels determined by the invention.

It is to be understood that all matter disclosed herein is to be interpreted merely as illustrative, and not in a limiting sense.

An important version of the system can be described as a computer based risk modeling process wherein a subject location is inputted for a user designated particular property, person, process or special events (hereafter referred to as an AOI or area of interest). The computer continuously searches threat and hazard data on a 24/7/365 worldwide basis by having several proprietary dictionaries autonomously and continuously employ data mining concepts. A wide variety of internet sources are searched for identification, categorization and location (latitudes and longitudes) of certain matches. Typical sources include RSS news feeds, private and government data bases, satellite feeds and social media. Matches (Threats) are selected if they are within pre-defined distances from AOIs, which distances have been preselected by subject matter experts depending upon the severity of the threat. After a match is discovered and categorized, users can click on that match and have access to the underlying sources from which the match was discovered e.g. full texts of articles, relevant sections of private and/or government databases, full texts of relevant twitter messages, etc. Cybersecurity vulnerability characteristics of the AOI are obtained from a self-assessment by users using a proprietary cyber assessment so that the answers can be evaluated and recorded on the computer as a first factor. Physical security vulnerability characteristics of the AOI are obtained from a self-assessment by user using a proprietary physical security assessment so that answers can be evaluated and recorded on the computer as a second factor. Physical security characteristics of nearby buildings and terrain features are obtained from a proprietary analysis of the 700 categories of 8 million relevant objects from the National Geospatial Intelligence Agency data base as a third factor. Furthermore, this analysis only displays on the electronic map of the invention, those buildings and terrain features which have a minimum pre-specified inherent risk factor to the AOI. Different threats facing AOI's will have different impacts upon nearby DAVA points. Each term has an associated fourth factor. For each match with any of the first factor, the second factor, and/or the third factor, the match is also evaluated by the computer in combination with a fourth factor resulting in an impact/consequence value associated with that match which also includes potential cascading effects of certain threats should they turn into actual events. A map is displayed by a visual element of the computer whereby AOIs are plotted on the map and then shown as an icon which is color coded in accordance with an overall risk scores assigned to each AOI by the inventions proprietary risk scoring process. The process may be optionally further characterized in that matches (the first factor) are either threats (manmade risks), hazards (naturally caused risks), or a technologically caused risks. The matches (threats) determined by the computer based risk modeling process can be further characterized by a proprietary determination of the severity of the impact/consequences for each match. The computer based risk modeling process can be further characterized in that the data sources from the worldwide internet are typically RSS news feeds, a social media, a government reports or data bases e.g. NOAA weather reports, US Geological Survey data, National Geospatial Intelligence Agency data, NASA and other such data sources.

An important version of the invention can be fairly described as a computer based risk modeling process or system where a computer is operatively connected, typically via a network or through the internet, to a first database containing a plurality of discrete terms. This is essentially a dictionary of terms that the system will eventually search for. Examples may include terms such as riot, flood, civil disobedience or any other term that may have a potential impact on security issues. The first database may have thousands of terms and may be updated and amended as needed. Each discrete term is associated with a predetermined severity factor. For example, the term ‘terrorism’ might have a higher risk factor than the term ‘unseasonable rain’ or ‘dam break’ might have a higher risk factor than ‘civil protest’. The computer searches an internet source for any of the discrete terms and when a first discrete term is found a hit data is recorded. The hit is typically comprised of the found first discrete term and its associated severity factor and the internet source. This hit is a piece of data that has information about what term was found during the search, the associated risk factor and more details about where the term was found (i.e. New York Times article published on a specific day and place). The computer analyzes the internet source and determines a source geolocation of the internet source and adds the first source geolocation to the hit data. Now the hit data includes information as to where the found term is geographically located and therefore where it might have a potential effect. A subject location is determined. This could be place such as a government center, a factory or any other place or region that security personnel are interested in monitoring and analyzing the potential security issues and risks. A cyber security characteristic within a first predetermined area relative to the subject location is evaluated and recorded as a first risk factor. The evaluation is generally specific to the identified subject location. Cybersecurity is one type of potential risk and could include, for example, presence of network firewalls, password security protocols in place, network encryption and any other factor with a cyber or computer component. For cyber security risks the first predetermined area could be global including communication satellites. Generally, also a physical security characteristic within a second predetermined area relative to the subject location is evaluated and recorded as a second risk factor. Examples of physical security risks can include, for example, types of door locks, fences, protocols and many other varieties of risks. A situational security characteristic within a third predetermined area relative to subject location is evaluated and recorded as a third risk factor. Situational risks are sometimes due to the situation of the evaluated location such as proximity to fire stations, dams, nuclear facilities or war zones. If the source geolocation is determined to be within the first predetermined area then a first score is derived from the first risk factor in combination with the hit data. If the source geolocation is determined to be within the second predetermined area then a second score is derived from the second risk factor in combination with the hit data. If the source geolocation is determined to be within the third predetermined area then a third score is derived from the third risk factor in combination with the hit data. The first score and the second score and the third score are used to determine an overall risk score. A particular algorithm can weight each of these scores to provide an overall, net risk result. A graphical representation of the overall risk score is visually displayed. This can be on a computer screen, a printed report or any way that the risk score can be communicated to a person. Sometimes this could be other than visually such as audible or otherwise. If visually displayed it may be useful to have the various elements of risk plotted on a map. For example, an score can be represented visually on a map at a location representative of the subject location. Often a user of the system would benefit from additional information about a risk assessment or risk score so a report with more details is optionally made available to the operator of the system.

What is claimed is:

1. A computer based risk modeling process wherein:
A computer is operatively connected to a first database containing a plurality of discrete terms;
Each discrete term is associated with a predetermined severity factor;
The computer searches an internet source for any of the discrete terms and when a first discrete term is found a hit data is recorded comprised of the found first discrete term and its associated severity factor and the internet source;
The computer analyzes the internet source and determines a source geolocation of the internet source and adds the first source geolocation to the hit data;
A subject location is determined;
A cyber security characteristic within a first predetermined area relative to the subject location is evaluated and recorded as a first risk factor;
A physical security characteristic within a second predetermined area relative to the subject location is evaluated and recorded as a second risk factor;
A situational security characteristic within a third predetermined area relative to subject location is evaluated and recorded as a third risk factor;
If the source geolocation is determined to be within the first predetermined area then a first score is derived from the first risk factor in combination with the hit data;
If the source geolocation is determined to be within the second predetermined area then a second score is derived from the second risk factor in combination with the hit data;
If the source geolocation is determined to be within the third predetermined area then a third score is derived from the third risk factor in combination with the hit data;
The first score and the second score and the third score are used to determine an overall risk score;
A graphical representation of the overall risk score is visually displayed.

2. A computer based risk modeling process as in claim 1 further characterized in that the overall risk score is visually displayed on a map where the subject location is presented on the map.

3. A computer based risk modeling process as in claim 1 further characterized in that the overall risk score is presented in a report.
